(19) United States
(12) Patent Application Publication
(10) Pub. No.: US 2014/0270024 A1
(43) Pub. Date: Sep. 18, 2014

(54) APPARATUS AND METHOD FOR DETECTION OF TIME TRACKING FAILURE

(71) Applicant: NOKIA CORPORATION, Espoo (FI)

(72) Inventor: Panayiotis Papadimitriou, Espoo (FI)

(73) Assignee: NOKIA CORPORATION, Espoo (FI)

(21) Appl. No.: 13/828,613

(22) Filed: Mar. 14, 2013

(51) Int. Cl. H04L 7/00

(52) U.S. Cl. CPC H04L 7/0008
USPC 375/355

(57) ABSTRACT

According to an example embodiment of this application, a method may include calculating a timing offset estimate based on a received reference signal; accumulating consecutive timing offset estimates to generate a cumulative timing offset estimate; comparing the cumulative timing offset estimate against a threshold; and determining whether a time tracking has failed based on the comparison between the cumulative timing offset estimate and the threshold.

### TECHNICAL FIELD

The present application relates generally to an apparatus and a method for detection of time tracking failure.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application.

In wireless communications, different collections of communication protocols are available to provide different types of services and capabilities. Long term evolution, LTE, is one of such collection of wireless communication protocols that extends and improves the performance of existing universal mobile telecommunications system, UMTS, protocols and is specified by different releases of the standard by the 3^{rd} generation partnership project, 3GPP, in the area of mobile network technology. Other non-limiting example wireless communication protocols include global system for mobile, GSM, high speed packet access, HSPA, and wireless local area network WLAN, worldwide interoperability for microwave access, WiMAX.

Orthogonal frequency division multiplexing, OFDM, is a method of encoding digital data on a number of spaced orthogonal subcarrier frequencies. To combat the multipath fading channel between a transmitter and a receiver, a cyclic prefix, CP, is created by selecting the last part of an OFDM packet, making a copy of it and placing the copy in front of the packet. So each OFDM symbol, including the cyclic prefix and the OFDM packet, is transmitted for a total symbol period that is longer than the packet period. OFDM has been developed into several wideband digital communication protocols such as digital television, WiMAX, LTE, and so on. OFDM system is sensitive to timing offset or timing error. Timing offset causes a linearly growing phase error within OFDM symbol and introduces inter-symbol interference, ISI, and/or inter-carrier interference, ICI.

### SUMMARY

Various aspects of examples of the invention are set out in the claims.

According to a first aspect of the present invention, there is provided a method comprising calculating a timing offset estimate based on a received reference signal; accumulating consecutive timing offset estimates to generate a cumulative timing offset estimate; comparing the cumulative timing offset estimate against a threshold; and determining whether a time tracking has failed based on the comparison between the cumulative timing offset estimate and the threshold.

According to a second aspect of the present invention, there is provided an apparatus comprising at least one processor, and at least one memory including computer program code, wherein the at least one memory and the computer program code configured to, with the at least one processor, cause the apparatus at least to calculate a timing offset estimate based on a received reference signal; accumulate consecutive timing offset estimates to generate a cumulative timing offset estimate; compare the cumulative timing offset estimate against a threshold; and determine whether a time tracking has failed based on the comparison between the cumulative timing offset estimate and the threshold.

According to a third aspect of the present invention, there is provided a computer program product comprising a computer-readable medium bearing computer program code embodied therein for use with a computer, the computer program code may include code for calculating a timing offset estimate based on a received reference signal; accumulating consecutive timing offset estimates to generate a cumulative timing offset estimate; comparing the cumulative timing offset estimate against a threshold; and determining whether a time tracking has failed based on the comparison between the cumulative timing offset estimate and the threshold.

According to a fourth aspect of the present invention, there is provided an apparatus comprising means for calculating a timing offset estimate based on a received reference signal; means for accumulating consecutive timing offset estimates to generate a cumulative timing offset estimate; means for comparing the cumulative timing offset estimate against a threshold; and means for determining whether a time tracking has failed based on the comparison between the cumulative timing offset estimate and the threshold.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention;

FIG. 2 illustrates how a timing offset estimate relates to the orthogonal frequency division multiplexing packet extraction in accordance with an example embodiment of the invention;

FIG. 3 illustrates a flow diagram of operating a receiver according to an example embodiment of the invention;

FIG. 4 illustrates a simplified block diagram of various example apparatuses that are suitable for use in practicing various example embodiments of this invention.

### DETAILED DESCRIPTION

In the illustration of various embodiments below, 3^{rd} generation partnership project, 3GPP, long term evolution, LTE, will be used as the non-limiting examples of the radio access technology. It is non-limiting and is presented for example only. FIG. 1 illustrates an example wireless system 100 in accordance with an example embodiment of the invention. The example wireless system 100 comprises three LTE evolved Node Bs, eNBs, 101, 103 and 105, each communicating with a user equipment, UE, 102, 104 and 106, respectively. Although three eNBs and just one UE for each eNB are shown in FIG. 1, the example wireless system 100 may comprise more or less eNBs and more UEs for each eNB.

The downlink communication from eNBs 101, 103 and 105 to the UEs 102, 104 and 106 is in form of frame that comprises a predetermined number of orthogonal frequency division multiplexing, OFDM, symbols. In an example embodiment, in order to correctly decode the downlink communication, the LTE receiver at UEs needs to first establish the coarse synchronization with the eNB. For example, the UE can coarsely detect the beginning of frame and identify the cell identity by correlating and searching for the primary synchronization signal, PSS, and the secondary synchronization signal, SSS, which are carried in the downlink communication.

After the initial coarse time synchronization, a fine time tracking, or fine timing offset estimation, can be performed by using a time tracking estimator at the receiver of a UE. The task of the time tracking estimator is to estimate and track closely the correct timing of the arriving OFDM symbols, so that the extracted OFDM packet will not suffer the inter-symbol interference, ISI, and/or the inter-carrier interference, ICI. In an example embodiment, for an LTE system, the timing offset may be estimated based on a reference signal (which is also known as pilot), such as for example, the cell-specific reference signal, CRS, and/or the UE-specific demodulation reference signal, DM-RS and/or the channel state information reference signal, CSI-RS.

FIG. 2 illustrates how the timing estimate relates to the OFDM packet extraction in accordance with an example embodiment of the invention. In the example of FIG. 2, it is assumed that the CP 203 has a short length of about 4.6875 μs. With a non-zero timing offset t 205, the window for packet extraction is not aligned with the packet 201 of an OFDM symbol 209. If the window for packet extraction begins inside the previous packet 207 due to the timing offset t 205, an ISI may be introduced. ISI may be caused also due to the channel delay spread if the start of the window for packet extraction is inside the CP 203, but very close to the boundary between the CP 203 and the previous packet 207. On the other hand, an ICI, in addition to ISI, may be incurred if the window for packet extraction begins inside the packet 201 due to the timing offset t 205. Therefore, the time tracking estimator is an important element of the baseband modem receiver. The time tracking estimator, under certain conditions, e.g. low SNR and/or high interference, may lose tracking/synchronization, i.e. the timing offset estimates it generates may be erroneous. This may cause the packet to fail detection, and hence decrease of UE data throughput will occur. Therefore, a fast way is needed to identify that the time tracking has failed (or equivalently that the receiver lost time synchronization), in order to avoid the waste of data packets and decrease of the UE data throughput.

In an example embodiment, a cumulative timing offset estimate may be used as the metric to determine whether the time tracking of OFDM symbols has failed or not. The cumulative timing offset estimate is defined as the sum of consecutive timing offset estimates, which are produced by the time tracking estimator. In other words, for every time window of length T, when there is a new timing offset estimate, the time tracking estimator adds it to the current cumulative timing offset estimate. In an example embodiment, T can be equal to one LTE subframe, or multiple of the LTE subframe duration. In an example embodiment, there may be multiple timing offset estimates within T and an overall timing offset estimate (for that time window T) can be obtained by averaging the multiple timing offset estimates within that window of time length T. The cumulative timing offset estimate is then compared against a threshold. If the threshold is exceeded, the time tracking is determined as failed, and the coarse synchronization may be reinitiated. In an example embodiment, the threshold is determined based on the length of the CP. In an example embodiment, the threshold may be equal to the CP length or a fraction of the CP length. In an example embodiment, the absolute value of the cumulative timing offset estimate is used. In another example embodiment, different threshold values may be used depending on the sign of the cumulative timing offset estimate. In an example embodiment, when the time tracking is determined as failed, the coarse synchronization is reinitiated to bring the timing offset estimate within the length of the CP.

In an example embodiment, after the initial coarse synchronization, a cumulative timing offset estimate is set to 0. Then every time when the time tracking estimator generates a new timing offset estimate, the cumulative timing offset estimate is updated as the current cumulative timing offset plus the new timing offset estimate. The updated cumulative timing offset estimate is compared against a threshold. If the updated cumulative timing offset estimate is exceeding the threshold, it is declared that the time tracking has failed and the coarse synchronization may be reinitiated; Otherwise, the time tracking estimator continues generating the timing offset estimate and updating the cumulative timing offset estimate.

FIG. 3 illustrates a flow diagram of operating a receiver according to an example embodiment of the invention. At 301, a time tracking estimator calculates a timing offset estimate based on a received reference signal. At 302, the time tracking estimator accumulates consecutive timing offset estimates to obtain a cumulative timing offset estimate. The cumulative timing offset estimate is compared against a threshold at 303. Based on the comparison, it is determined at 304 whether the time tracking has failed.

Reference is made to FIG. 4 for illustrating a simplified block diagram of various example apparatuses that are suitable for use in practicing various example embodiments of this invention. In FIG. 4, a wireless network 400 is adapted for communication with a UE 411 via a network element 401. The UE 411 includes at least one processor 415, at least one memory (MEM) 414 coupled to the at least one processor 415, and a suitable transceiver (TRANS) 413 (having a transmitter (TX) and a receiver (RX)) coupled to the at least one processor 415. The at least one MEM 414 stores a program (PROG) 412. The TRANS 413 is for bidirectional wireless communications with the NE 401.

The NE 401 includes at least one processor 405, at least one memory (MEM) 404 coupled to the at least one processor 405, and a suitable transceiver (TRANS) 403 (having a transmitter (TX) and a receiver (RX)) coupled to the at least one processor 405. The at least one MEM 404 stores a program (PROG) 402. The TRANS 403 is for bidirectional wireless communications with the UE 411. The NE 401 is coupled to one or more external networks or systems, which is not shown in this figure.

As shown in FIG. 4, the NE 401 may further include a reference signal generation unit 406, for generating a reference signal that can be received and used by the UE 411 for estimating the timing offset. The unit 406, together with the at least one processor 405 and the PROG 402, may be utilized by the NE 401 in conjunction with various example embodiments of the application, as described herein.

As shown in FIG. 4, the UE 411 may further include a time tracking estimator 416, for calculating a timing offset estimate based on a received reference signal, accumulating consecutive timing offset estimates to obtain a cumulative timing offset estimate, comparing the cumulative timing offset estimate against a threshold, and determining whether the time tracking has failed based on the comparision. The unit 416, together with the at least one processor 415 and the PROG 412, may be utilized by the UE 411 in conjunction with various example embodiments of the application, as described herein.

At least one of the PROGs 402 and 412 is assumed to include program instructions that, when executed by the associated processor, enable the electronic apparatus to operate in accordance with the example embodiments of this disclosure, as discussed herein.

In general, the various example embodiments of the apparatus 411 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The example embodiments of this disclosure may be implemented by computer software or computer program code executable by one or more of the processors 405, 415 of the NE 401 and the UE 411, or by hardware, or by a combination of software and hardware.

The MEMs 404 and 414 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The processors 405 and 415 may be of any type suitable to the local technical environment, and may include one or more of general purpose computers, special purpose computers, microprocessors, digital signal processors (DSPs) and processors based on multi-core processor architecture, as non-limiting examples.

Without in any way limiting the scope, interpretation, or application of the claims appearing below, a technical effect of one or more of the example embodiments disclosed herein may be promptly detecting whether the time tracking has failed at a receiver. This helps to reduce the receiver complexity and power consumption, since when a UE determines that the time tracking has failed for a received OFDM symbol, it does not need to perform decoding of that packet. Another technical effect herein may be improving the system throughput, because the UE saves the time that it would spend to decode an almost-certain-to-fail packet when the time tracking has failed.

Embodiments of the present invention may be implemented in software, hardware, application logic or a combination of software, hardware and application logic. The software, application logic and/or hardware may reside on an apparatus such as a user equipment, a NodeB or other mobile communication devices. If desired, part of the software, application logic and/or hardware may reside on a macro eNodeB/base station 401, part of the software, application logic and/or hardware may reside on a UE 411, and part of the software, application logic and/or hardware may reside on other chipset or integrated circuit. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

Further, the various names used for the described parameters are not intended to be limiting in any respect, as these parameters may be identified by any suitable names. In addition, the timing offset estimation may happen in the uplink according to the various embodiments, therefore in that case the eNB performs the timing offset estimation.

If desired, the different functions discussed herein may be performed in a different order and/or concurrently with each other. Furthermore, if desired, one or more of the above-described functions may be optional or may be combined. As such, the foregoing description should be considered as merely illustrative of the principles, teachings and example embodiments of this invention, and not in limitation thereof.

What is claimed is:

1. A method, comprising:
calculating a timing offset estimate based on a received reference signal;
accumulating consecutive timing offset estimates to generate a cumulative timing offset estimate;
comparing the cumulative timing offset estimate against a threshold; and
determining whether a time tracking has failed based on the comparison between the cumulative timing offset estimate and the threshold.

2. The method of claim 1, wherein:
comparing the cumulative timing offset estimate against a threshold comprises using the absolute value of the cumulative timing offset estimate.

3. The method of claim 1, wherein:
comparing the cumulative timing offset estimate against a threshold comprises using different threshold values depending on the sign of the cumulative timing offset estimate.

4. The method of claim 1, wherein the threshold is determined based on the length of the cyclic prefix of an orthogonal frequency division multiplexing system.

5. The method of claim 1, wherein:
comparing the cumulative timing offset estimate against a threshold comprises determining whether the cumulative timing offset estimate exceeds the threshold.

6. The method of claim 1, further comprising:
reinitiating a coarse time synchronization process when it is determined that the time tracking has failed.

7. The method of claim 6, wherein:
reinitiating the coarse time synchronization comprises detecting at least one of a primary synchronization signal and a secondary synchronization signal.

8. An apparatus comprising:
at least one processor, and at least one memory including computer program code, wherein the at least one memory and the computer program code configured to, with the at least one processor, cause the apparatus at least to:
calculate a timing offset estimate based on a received reference signal;
accumulate consecutive timing offset estimates to generate a cumulative timing offset estimate;
compare the cumulative timing offset estimate against a threshold; and
determine whether a time tracking has failed based on the comparison between the cumulative timing offset estimate and the threshold.

9. The apparatus of claim 8, wherein:
the apparatus compares the cumulative timing offset estimate against a threshold by using the absolute value of the cumulative timing offset estimate.

10. The apparatus of claim 8, wherein:
the apparatus compares the cumulative timing offset estimate against a threshold by using different threshold values depending on the sign of the cumulative timing offset estimate.

11. The apparatus of claim 8, wherein the threshold is determined based on the length of the cyclic prefix of an orthogonal frequency division multiplexing system.

12. The apparatus of claim 8, wherein:
the apparatus compares the cumulative timing offset estimate against a threshold by determining whether the cumulative timing offset estimate exceeds the threshold.

13. The apparatus of claim 8, wherein the at least one memory and the computer program code configured to, with the at least one processor, cause the apparatus further to:
reinitiate a coarse time synchronization process when it is determined that the time tracking has failed.

14. The apparatus of claim 13, wherein:
the apparatus reinitiates the coarse time synchronization process by detecting at least one of a primary synchronization signal and a secondary synchronization signal.

15. A computer program product comprising a computer-readable medium bearing computer program code embodied therein for use with a computer, the computer program code includes code for:
calculating a timing offset estimate based on a received reference signal;
accumulating consecutive timing offset estimates to generate a cumulative timing offset estimate;
comparing the cumulative timing offset estimate against a threshold; and
determining whether a time tracking has failed based on the comparison between the cumulative timing offset estimate and the threshold.

16. The computer program product of claim 15, wherein the code for comparing the cumulative timing offset estimate against a threshold comprises:
code for using the absolute value of the cumulative timing offset estimate.

17. The computer program product of claim 15, wherein the code for comparing the cumulative timing offset estimate against a threshold comprises:
code for using different threshold values depending on the sign of the cumulative timing offset estimate.

18. The computer program product of claim 15, wherein the threshold is determined based on the length of the cyclic prefix of an orthogonal frequency division multiplexing system.

19. The computer program product of claim 15, wherein the code for comparing the cumulative timing offset estimate against a threshold comprises:
code for determining whether the cumulative timing offset estimate exceeds the threshold.

20. The computer program product of claim 15, wherein the computer program code further includes:
code for reinitiating a coarse time synchronization process when it is determined that the time tracking has failed.
